(19) United States
(12) Patent Application Publication
(10) Pub. No.: US 2008/0124499 A1
(43) Pub. Date: May 29, 2008

(54) Printing Paper and a Method for the Production Thereof

(76) Inventors: Helen Sundvall, Domsjo (SE); Nils Pauler, Sjalevad (SE); Ake Karlin, Domsjo (SE); Carin Nordin, Sidensjo (SE)

Correspondence Address: KUBOVCIK & KUBOVCIK, SUITE 1105, 1215 SOUTH CLARK STREET, ARLINGTON, VA, 22202, US

(21) Appl. No.: 11/793,812

(22) PCT Filed: Dec. 22, 2005
(86) PCT No.: PCT/FI05/00547

§ 371 Date: Jun. 22, 2007

(30) Foreign Application Priority Data
Dec. 23, 2004 (FI) 20041664

(51) Int. Cl. B41M 5/00; D21C 5/00

(52) U.S. Cl. 428/32.2; 428/32.21; 428/32.18; 162/5

(57) ABSTRACT

Printing papers, comprising a cellulosic or lignocellulosic web, which contains fillers and an internal sizing agent, and a method for the production thereof. According to the invention, the paper contains a cationic fixing agent applied on the surface of the web, and it exhibits black ink absorption which is 40%±10% of the absorption of coloured ink at 1.0. second and 70%±15% of the absorption of coloured ink at 2.0 seconds, and maximum absorption determined by Emtec standard absorption analyses in the range of 0.3 to 0.5 seconds. The present invention provides multipurpose printing papers for the high-speed inkjet printing technique.

The present invention relates to printing papers and methods for producing such papers. In particular, the present invention relates to a high-speed inkjet printing paper in accordance with the preamble of claim 1.

Such a paper typically comprises a cellulosic or lignocellulosic matrix, which contains fillers and internal sizing agents.

The present invention also concerns a method according to the preamble of claim 11, wherein a cellulosic or lignocellulosic web is formed on a paper or cardboard machine from a furnish containing and cellulosic or lignocellulosic fibre, an internal sizing agent and fillers.

New inkjet printers are very fast. The speed of printing is up to 150 m/min, and the print head supplies up to 50 ml/m² water-based ink, having a solids content of about 2%. The normal drop size is 10 pl=10×10-12 dm³, which means that on every square metre of the printed surface, the print head will apply 500 M dots, i.e. 500 dots/mm² of the paper. A specific example of a printer operating at the above conditions is the high-speed four-colour inkjet printer Kodak VersaMark.

In high-speed inkjet printers it is, in practice, impossible to use conventional paper grades known as “multifunctional papers” which have been developed for desktop inkjet printers of the kind typically example supplied by Hewlett-Packard and Epson. The paper used in a high-speed inkjet printer has to have improved properties to give good printing results since the printing technique of the Kodak VersaMark printer and the inks used therein differ from those of normal desktop inkjet printers. In particular, the paper must be able to take up and keep the applied ink and prevent it from spreading out from the original dots. It is not, however, merely sufficient to reduce smear of the ink since, in some applications, such as bar-code printing, too high fixation of the ink can be detrimental to the print result. Therefore, there is a need for a new grade of multifunctional printing paper, which will meet the demands of high-speed inkjet printers.

As known in the art, inkjet printing papers can be uncoated or they can be coated with pigments. Often the pigment coating contains finely divided SiO₂ pigments, but also precipitated calcium carbonate (PCC) is being used and, to some extent, even titanium dioxide (TiO₂).

By properly selecting and modifying the coating pigments and their binders, some improvement of the printing result can be obtained. Thus, for very fine printing quality the pigment particles of a coated printing paper must be as small as possible. Fine particle coating is, however, expensive and there are also other problems. Thus, e.g. PCC is quite hydrophobic and it is best suited for use only with oil-based inks. With water-based inks, SiO₂ is better, but it requires that a special kind of binding polymer be used.

Improved ink-receiving papers, based on modified pigment coatings, are disclosed in the patent literature. For example, U.S. Pat. No. 6,582,802 describes a paper where inorganic fine particles are bound together with polyvinyl alcohol and that binder is hardened with boric acid.

U.S. Pat. No. 6,632,487 discloses coatings made in the dry state, where inorganic particles are bonded together by melting an organic resin and binding inorganic particles also to the substrate.

U.S. Pat. No. 6,682,788 deals with organic resin particles with polyvinyl alcohol where the PVA is hardened with acid and salts thereof.

U.S. Pat. No. 6,685,999 discloses a receiving sheet, coated with two different layers, where the lower layer is a porous layer of hydrated alumina and the upper layer comprises silica particle agglomerates. The silica particles have separate particle size in the range of 1 to 10 nm and the voids are mainly located on the outside of the agglomerates. The layers are dry so that the glass transition temperature of the binding polymers is exceeded.

U.S. Pat. No. 6,699,536 describes an inkjet recording sheet, where inorganic particles are bound together with polyvinyl alcohol and at least two cationic polymers having quaternary ammonium salts are used and also a compound containing zirconium atom or aluminium atom other than zirconium or aluminium oxide.

For colour photographs, printed from images taken with a normal digital camera, coated papers or coated polymer sheet with any of the above, e.g. SiO₂ containing coatings, are excellent solutions. Here the printing of an A4 size image takes from 1 to 4 min. However, when the speed of printing is manifold to that, ink absorption must be very fast and ink spread out should also be minimized. A layer formed by complex fine particles does not absorb ink rapidly enough, and dot quality is not sufficiently good for that purpose. Furthermore, printing base papers of the kind suggested in the above patents, are very expensive to produce.

Thus, it is an aim of the present invention to eliminate at least some of the problems of the prior art and to provide a novel kind of multipurpose inkjet printing paper and a method for the production thereof.

Published International Patent Application WO 2004/096566 discloses a method for improving printability on paper with the aid of the ink-jet printing method. In the known method papers are treated with aqueous solutions containing cationic polymers whose charge density is equal to or higher than 3 mVal/g and which are used as sole treating agent in the aqueous solution. The cationic polymer is applied to a paper in quantities ranging from 0.05 to 5.0 g/m².

We have found that the rather broad ranges giving in WO 2004/096566 are not at all sufficient for establishing a working window for the production of high-quality printing papers for inkjet printing. Further, the publication is silent about importance of the relation between colour and black ink absorption on the printing result.

The present invention is based on the finding that in order for the paper to meet the specific and stringent requirements by high-speed inkjet printing, it must simultaneously exhibit the following properties:
Moderate ink absorption which is high enough to prevent ink smearing and to give good four colour print quality but not too high for barcode properties; and
Good water fastness and a capability of binding the ink on the surface of the fibres for preventing ink from spreading out from the dots printed on the paper.

According to the present invention, the above-mentioned basic aims can be economically attained by using basically conventional paper grades, where opacity is achieved with an inexpensive (mineral) filler. Instead of employing a special kind of pigment coating for obtaining the desired properties of ink absorption and fixation, this kind of paper can be modified by surface treatment and internal sizing to meet the requirements of high-speed inkjet printing.

More particularly, a paper akin of a conventional offset printing paper grade can be modified for printing with water-based inks, which contain anionic dyes, by using a cationic fixing agent for improving the level of ink fixation. The cationic fixing agent can be of the kind primarily developed for trash fixation in papermaking. As an example of a suitable group of fixation agents, cationic polyamines can be mentioned.

Conventionally, some internal sizing is always necessary in conventional cellulosic or lignocellulosic papers with mineral fillers. We have found that in the present context it is advantageous to use only a moderate or low level of internal sizing in order to obtain sufficiently high ink absorption.

Finally, if necessary, the smoothness of the paper surface can be adjusted by calendaring or by using other techniques for smoothening of the paper surface to influence ink absorption.

As a result, by surface treatment with a cationic fixing agent, by selecting a limited degree of internal sizing and by adjusting the surface smoothness, it is possible reproducibly to achieve a window of operation, where excellent four colour print quality and good barcode properties are simultaneously achieved. Such properties are manifested in that the paper exhibits, after selection of proper concentrations of cationic fixing agent and internal sizing:
a. black ink absorption which is 40%±10% of the absorption of coloured ink at 1.0. second and 70%±15% of the absorption of coloured ink at 2.0. seconds, and
b. maximum absorption determined by Emtec standard absorption analyses in the range of 0.3 to 0.5 seconds.

More specifically, the paper according to the present invention is mainly characterized by what is stated in the characterizing part of claim 1.

The method according to the invention is characterized by what is stated in the characterizing part of claim 12.

The use according to the invention is characterized by what is stated in claim 20.

Considerable advantages are obtained by the present invention. Thus, as discussed above, the present papers provide for good multipurpose printing by high-speed inkjet printing technique. Expensive fine inorganic particles are unnecessary in our new paper. The right balance between internal sizing and surface cationic fixing are key factors for producing an inexpensive good ink-jet printing recording sheet.

As will appear, a 3-dimensional window has developed where anionic water based inks are functioning with high-speed ink-jet printing. The window, where both color image quality and black image quality are simultaneously good is narrow but it is reproducible in production scale.

Next, the invention will be examined more closely with the aid of a detailed description and illustrated with working examples.

In the description, reference is made to the attached drawings,

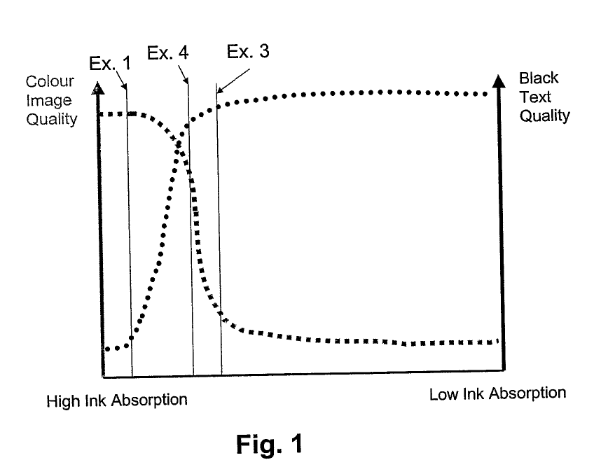

FIG. 1 is a principal graph showing how colour image quality and black text quality are influenced by ink absorption;

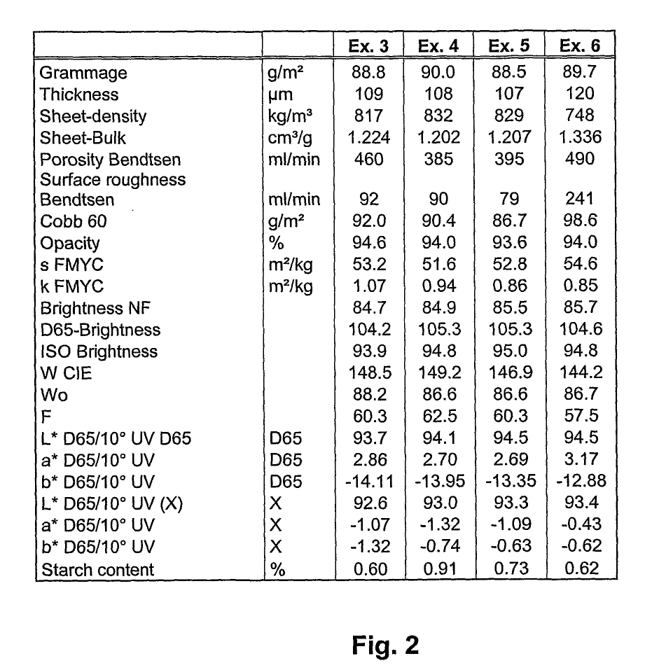

FIG. 2 is a table containing data for the six paper samples tested;

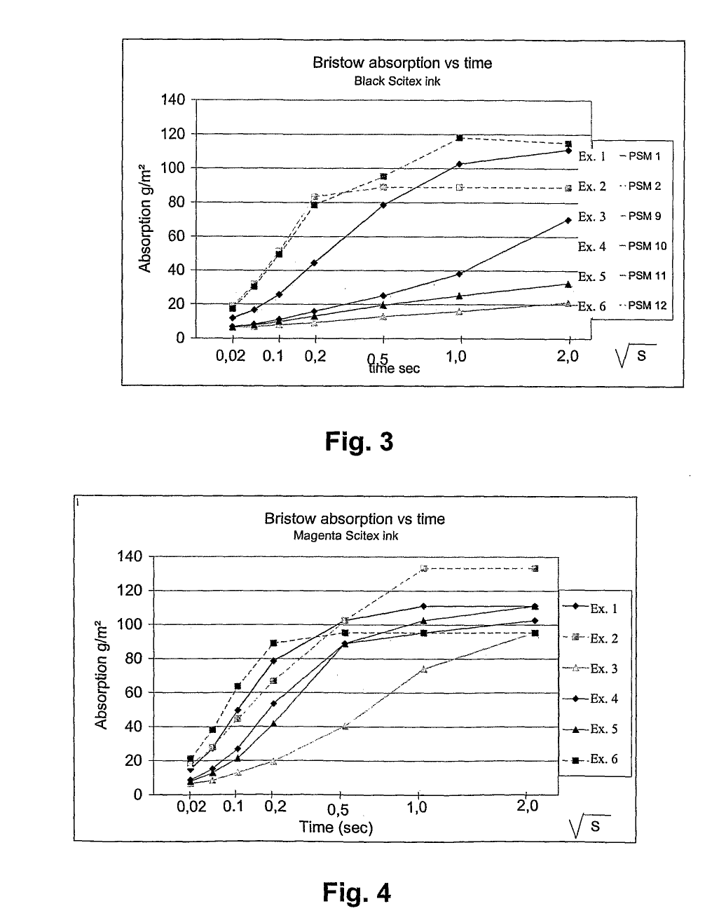

FIG. 3 shows a comparison of absorption (Black Kodak VersaMark ink) for paper samples abbreviated Ex. 1, Ex. 2, Ex. 3, Ex. 4, Ex. 5 and Ex. 6—the absorption is analysed with Bristow wheel;

FIG. 4 shows a comparison of absorption (Magenta Kodak VersaMark ink) for paper samples Ex. 1, Ex. 2, Ex. 3, Ex. 4, Ex. 5 and Ex. 6—the absorption is analysed with Bristow wheel;

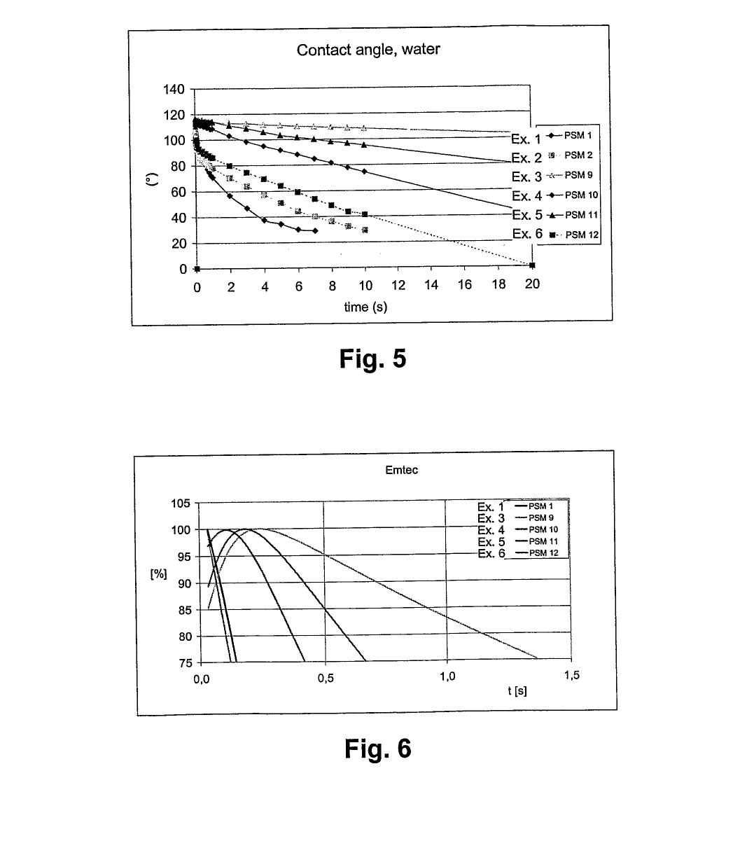

FIG. 5 shows a comparison of contact angle for the samples Ex. 1, Ex. 2, Ex. 3, Ex. 4, Ex. 5 and Ex. 6 (angle as a function of time);

FIG. 6 indicates in graphical form the initial absorption curves from Emtec analyses (percentages as a function of time);

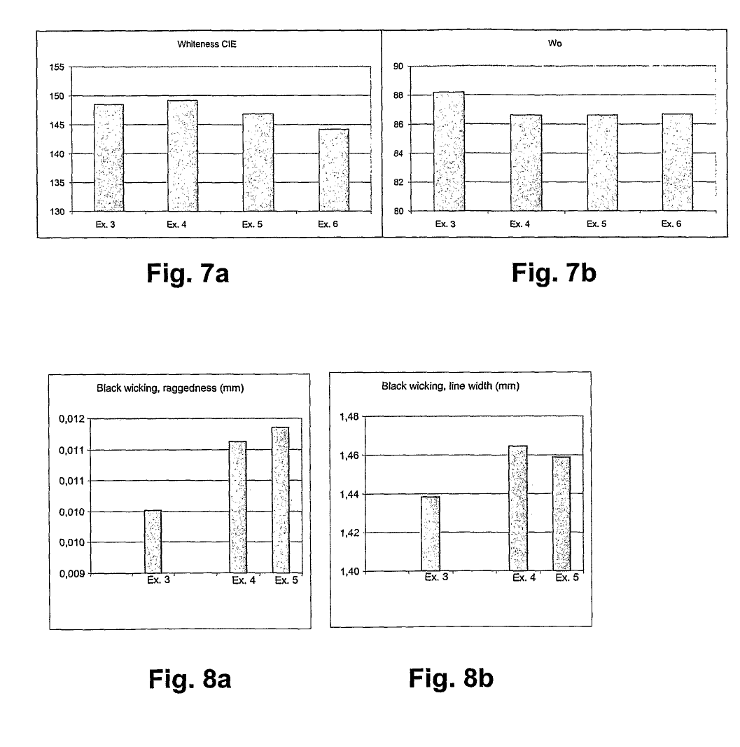

FIGS. 7a and 7b are bar charts showing Whiteness measured with (Whiteness CIE) and without (WO) the fluorescing part for different samples;

FIGS. 8a and 8b indicate the result of black print quality—FIG. 8a raggedness and FIG. 8b line width;

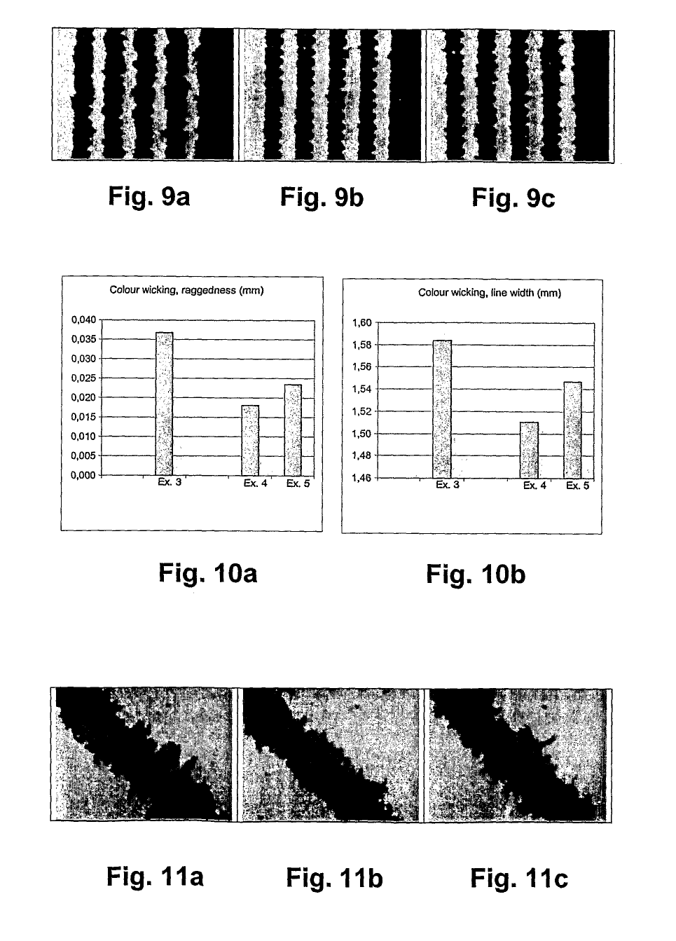

FIGS. 9a to 9c show microscopic photo of barcode quality (×100): FIG. 9a: Ex. 1 printed at a first date, FIG. 9b: Ex. 3 printed one month later and FIG. 9c: Ex. 4 printed two months later;

FIGS. 10a and 10b indicate the results of colour print quality from the two test printings at a commercial printing house, FIG. 10a raggedness and FIG. 10 b line width;

FIGS. 11a to 11c are microscopic photo of a black line on a yellow surface. (×100): FIG. 11a: Ex. 3, FIG. 11b: Ex. 4 and FIG. 11c: Ex. 5; and

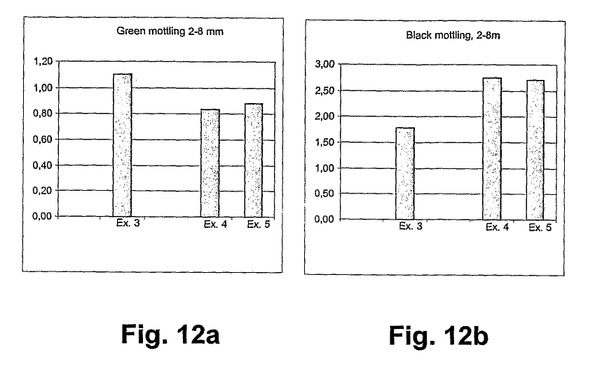

FIGS. 12a and 12b are bar charts showing green and black mottle, respectively, from full-scale printing at a commercial printing house.

According to the present invention, as discussed above, for obtaining a good multipurpose printing paper, a balance must be established between ink absorption for good high-speed color print quality and moderately good ink absorption for proper bar-code quality.

The first step is to produce a base paper from cellulosic or lignocellulosic fibres, which contains filler and other conventional admixtures along with internal sizing agent.

The fibres are preferably derived from chemical paper pulp, produced by alkaline cooking method (kraft pulping, for instance). The fibres can be derived from hardwood or softwood or they can comprise mixture of hardwood and softwood fibres. The mass proportions of such mixtures are generally 90:10 to 10:90.

The paper can contain any conventional and special filler for obtaining the desired level of opacity. Typically, calcium salts are used, GCC (ground calcium carbonate) and PCC (participated calcium carbonate) being particularly preferred. A filler loading of about 10 to 30% is conventional; preferably fillers are used in an amount of about 15 to 20%, of the paper weight.

It is well known that surface sizing agents are hydrolyzed within the paper as a function of time, which is a competing reaction with the bonding of the agent to —OH groups of the pulp fibers. For this reason, the sizing agent should be a sizing agent, where the hydrolysis rate as a function of time, temperature and pH is taken is only slow.

The furnish contains generally 0.01 to 5%, preferably less than about 1%, in particular about 0.01 to 0.1%, of the dry matter of the fibre at least one sizing agent.

As known in the art, the main groups of sizing agents comprise rosin soap size, rosin emulsion size, alkenylsuccinic anhydride (ASA), and alklylketene dimer (AKD). Any sizing agent suitable for use at the actual papernaking conditions can be employed. When the filler used comprises a calcium salt, papermaking is usually carried out at alkaline or and neutral conditions, and the preferred sizing agents are of the alkylketene dimer (AKD) or alkenyl succinic anhydride (ASA) type.

For ASA, in particular, the suitable dosage is about 0.04-0.06%, in particular about 0.041 to 0.52% from the weight of the paper.

Alkylketene dimer sizing agents are traditionally synthesized from fatty acids. The most common form is a waxy solid material dispersed as small particles in a solution that contains a stabilizer. The stabilizer may be cationic starch or another cationic polyelectrolyte. Unsaturated fatty acids can also be used to make a liquid form of AKD.

The alkylketene dimer (AKD) can be derived from hydrocarbyl residues having from 8 to 30 carbon atoms. The AKD may have a small influence on the cationic fixing agent less and, in that respect, it may represent a preferred embodiment.

The alkenylsuccinic anhydride comprises an oily monomer as active ingredient. For papermaking, the most important components of the monomer are a five-membered anhydride ring and a linear chain having generally between 14 and 20 —CH₂— groups. The reactive ring can be at various positions relative to the chain. Often, the commercial ASA's consist of a mixture of these isomers. The product is typically delivered as a light amber oil. ASA is added to the furnish in the form of an aqueous emulsion, in which the stabilizer is usually cationic starch or another cationic, hydrophilic polyelectrolyte

As a particular example of a suitable compound, n-octenyl-alkenylsuccinate anhydride can be mentioned.

In order to obtain a suitable ink absorption on a modest or low level of internal sizing, alkenyl succhinic anhydride, ASA, was used in a concentration of about 0.040 to 0.060%, calculated based on the dry weight of the paper.

The particular advantage of using these organic sizing chemicals (AKD, ASA) in the present context is that they undergo only slowly hydrolysis in water.

The sizing will also effect the surface treatment, agent penetration and amount needed of that. The key feature is, however, the level of ink absorption rate balanced between black ink and color inks. The black ink absorption must be less than color inks absorption, in order to keep mainly bar codes sharp enough.

Surface treatment with an aliphatic polyamine derivative (e.g., Cartafix DPR, supplied by Clariant) can be made to achieve the desired level of ink fixation on the paper surface. The Cartafix is chemically a polymer of dimethylaminopropylamine units, which are linked together with epichlorohydrin residues. The polymer can be used in the form of sulphate salt.

The fixing agent can be applied to the paper surface in manners known per se, e.g. by a size-press, although it is also possible to apply the fixing agent with film-press, spraying or even by calendar. The dosage is conventionally about 1 g/m², but we have found that for proper results, somewhat higher application amounts are needed (about 1.5 to 3 g/m², preferably about 1.75 to 2.25 g/m², in particular 1.8 to 2.2 g/m², the amounts being calculated for the whole paper (both sides together). By setting the dosage at about 2 g/m², in practice an application amount of about 1.8 to 2.2 g/m² will be reached at the paper mill. In addition to the polyamine derivatives of the above kind, various other fixing agents can also be used. Examples include chemical agents comprising polyethylene imine and derivatives thereof, polyamidoamines and derivatives thereof, polyamido amine epichlorohydrin resins, and polydiallyldimethyl ammonium chloride. The “derivatives” include various salts, in particular salts of inorganic (e.g. mineral) and organic acids.

As regards surface smoothness, we have found that a roughness (paper smoothness) of about 100±20 ml/min (Bentsen), in particular 100±15 ml/min or 100±10 ml/min (Bentsen), preferably about 95 to 85 ml/min (Bentsen) gives the best results. Generally, both on-line and off-line calendering can be used, although on-line calendering is often sufficient to reach the desired level of surface smoothness.

Bulk density is preferably fixed at 800±50 kg/m³, in particular about 800±25 kg/m³. The grammage of the paper is typically about 50 to 160 g/m², in particular about 80 to 120 g/m².

The final rule, we found, to make acceptable and excellent product was: Black ink (Kodak VersaMark ink) absorption, in Bristow wheel standard test equipment, was about 40% of Magenta ink (Kodak VersaMark ink) absorption at a time of 1.0 seconds and about 70% at 2.0 seconds. In this window, the product works well. Emtec standard absorption measurement showed a maximum for the same product between 0.3 and 0.5 seconds. Generally, some deviation from the above values are possible. Hence, we have found that, according to the invention, black ink absorption should be 40%±10%, in particular 40%±5%, of the absorption of coloured ink at 1.0. second and 70%±15%, in particular 70%±5%, of the absorption of coloured ink at 2.0. seconds. The Emtec standard absorption measurement can show a maximum at about 0.35 to 0.45 seconds.

As will be discussed in more detail below, the above features are important, and any significant deviations will result in impaired performance of the paper.

Full-scale trials have verified the above-discussed contradictory relation between black print quality and colour print quality. The trials also have shown that the production window is very narrow and small changes give large effects. By using a combination of right internal sizing, surface treatment like cationic fixing agent and mechanical treatments like calendering, it is, however, possible to obtain the required print results.

FIG. 1 is a principal graph showing how colour image quality and black text quality are influenced by ink absorption. In the figure, three full-scale trials denoted Ex. 4, Ex. 3 and Ex. 1 are indicated. The inks used in the printer were anionic waterbased dyes with a solid content of 2%. The amount of ink put on the paper was for a four-colour picture around 50 ml/m². The speed of the printer was very fast (150 m/min).

The figure shows how both colour image and black text image can be obtained with required quality by adjusting ink absorption to be within the operation window according to the invention. Ex. 4 is such a product. Best compromise between black barcode quality and colour print quality was obtained with sample Ex. 4. Therefore, according to a particularly preferred embodiment of the invention, for the paper the Colour Image Quality and Black Text Quality as a function of Ink Absorption lies in the area between the two vertical lines corresponding to sample Ex. 1 and sample Ex. 3, respectively, in FIG. 1.

Next, the invention will be examined more closely with the aid of a detailed description and a number of working examples.

### EXAMPLE 1

In total, six paper samples are examined more closely below for their applicability in high-speed inkjet printing. Table 1 gives data on the six paper samples:

TABLE 1
Recipes of paper samples

| | Ex. 1 | Ex. 2 | Ex. 3 | Ex. 4 | Ex. 5 | Ex. 6 |
|---|---|---|---|---|---|---|
| Softwood, % | 25 | 25 | 25 | 25 | 25 | 25 |
| Hardwood, % | 75 | 75 | 75 | 75 | 75 | 75 |
| Filler, GCC | 15 | 15 | 17 | 17 | 17 | 17 |
| EW 632, % | | | | | | |
| ASA, % | 0.043 | 0.043 | 0.06 | 0.043 | 0.05 | 0.043 |
| Cobb 60, g/m² | 119/123 | 122/123 | 92/85 | 90/93 | 87/83 | 99/101 |
| Roughness, | 259/286 | 235/264 | 92/90 | 90/84 | 79/80 | 241/199 |
| ml/min | | | | | | |
| *Cartafix, g/m² | 2.34 | 0 | 1.94 | 1.95 | 1.95 | 0 |
| Calender | No | No | Yes | Yes | Yes | No |

*calculated in PSM from production data

### EXAMPLE 2

The ink absorption has been identified to be the critical property to obtain the required colour print and black print quality. Therefore, the produced papers have been analysed with different types of water and ink absorption test methods (Bristow, Emtec and Cobb 60).

### A. Paper Analyses

All test results from analysing paper properties are indicated in FIG. 2.

### B. Bristow Analyses

The ink absorption according to the Bristow method differs between the samples. For black ink high absorption was observed for Ex. 1, Ex. 2 and Ex. 6, low absorption for Ex. 5 and 6 whereas Ex. 4 had absorption properties between these two groups, see FIG. 3.

For colour print Ex. 1 has the highest absorption and also initial absorption of magenta ink compared to Ex. 3-5. The non-calendered Ex. 1, Ex. 2 and Ex. 6 with low internal sizing have higher ink absorption compared with Ex. 3-5 that were calendered and had higher ASA dosage. The absolutely lowest absorption was exhibited by Ex. 3 with the highest ASA dosage, see FIG. 4. Again, sample Ex. 4 is in the middle range of ink absorption.

### C. Surface Energy

Surface energy also affects how the ink penetrates the paper surface. To find out if the paper samples have different surface energy the contact angle is measured.

### D. Contact Angle

Contact angle is important and the analyses group the tested papers into two groups, see FIG. 5. One group is Ex. 1 and the two base papers Ex. 2 and Ex. 6. These papers start around contact angle 100° and have a fairly steep slope. The other group of papers is Ex. 3 to 5 with high and relative constant contact angle. The contact angle of Ex. 4 has a steeper slope but not as steep as the group of Ex. 1, Ex. 2 and Ex. 6.

### E. Emtec Absorption

The initial absorption is clearly seen when the papers are analysed with Emtec, results are given in FIG. 6. Ex. 1 and Ex. 6 start to absorb immediately compared with the Ex. 3 to 5. The absorption for Ex. 3 to 5 starts when the slope has passed the maximum peak. The first maximum has Ex. 4, then comes Ex. 5 and the last is Ex. 3.

### F. Optical Properties

In the final stage of the project the customer also asked for higher whiteness. In FIG. 7 the whiteness levels are shown. The results show that there will be no problems producing whiteness level of 150 even though large amounts of cationic fixing agent are used in the surface treatment.

### EXAMPLE 3

### Full-Scale Printing

The results from full-scale test printing made at a conventional printing house are given below.

The results are derived from analysing printed samples of M-real's test form using image analysing based on a method called Inkvar. All measured values from hikvar are based on perception studies and this evaluation has been found to be relevant for assessing colour print and bar-code properties.

### A. Black Print Quality

Black line properties like raggedness and line width is better for Ex. 3 compared to Ex. 4 and 5, see FIG. 8. The difference is so large so the human eye can see it on the barcode quality, see FIG. 9. FIG. 9 shows also a photo of a barcode on Ex. 1. Here it is clearly seen why the barcode properties of Ex. 1 are not satisfactory.

### B. Colour Print Quality

### Colour Wicking

Colour wicking is best for Ex. 4 compared to Ex. 5 and Ex. 3 that had lower ink absorption, see FIG. 10. Ex. 3 exhibits the most inferior results. These differences can clearly be seen in photos from the two full-scale test printings in FIG. 11.

### Mottle

Mottle is a value on how even black and coloured surfaces are. The lower value the more even is the printed surface. The results of mottle at the full-scale print trials show good results for Ex. 3 for black mottle but the opposite result for green mottle. Ex. 4 and 5 has good green mottle and not so good black mottle, see FIG. 12.

1. Paper for high-speed inkjet printing, comprising
a cellulosic or lignocellulosic web, which contains fillers and an internal sizing agent,
characterized in that
it contains a cationic fixing agent applied on the surface of the web, and
it exhibits
a. black ink absorption which is 40%±10% of the absorption of coloured ink at 1.0. second and 70%±15% of the absorption of coloured ink at 2.0 seconds, and
b. maximum absorption determined by Emtec standard absorption analyses in the range of 0.3 to 0.5 seconds.

2. The paper according to the claim 1, wherein printing inks absorption is balanced and regulated by internal sizing and surface treatment with a cationic fixing agent.

3. The paper according to claim 1, wherein paper smoothness is 100±20 ml/min by Bentsen.

4. The paper according to claim 1, wherein the concentration of the internal sizing agent is in the range of about 0.01 to 1%, preferably of 0.01 to 0.1%, of the dry matter of the fibre.

5. The paper according to claim 1, wherein the internal sizing agent is an alkylketene dimer, derived from hydrocarbyl residues having from 8 to 30 carbon atoms, or an alkyl succhinic acid anhydride, wherein the alkyl residue comprises a linear or branched hydrocarbyl residue with 1 to 10 carbon atoms.

6. The paper according to claim 5, wherein the concentration of alkyl succhinic acid anhydride used as an internal sizing agent is about 0.01 to 0.1%, preferably about 0.04-0.06%, in particular about 0.041 to 0.52% from the weight of the paper.

7. The paper according to claim 1, wherein the cationic fixing agent is selected from the group of aliphatic cationic polyamine and derivatives thereof, polyethylene imine and derivatives thereof, polyamidoamines and derivatives thereof, polyamido amine epichlorohydrin resins, and polydiallyldimethyl ammonium chloride.

8. The paper according to claim 7, wherein an aliphatic cationic polyamine derivative is used as a fixing agent at a dosage of about 1.5 to 3 g/m², preferably about 1.75 to 2.25 g/m², in particular 1.80 to 2.20 g/m², for example about 2.00 g/m².

9. The paper according to claim 1, wherein the bulk density is about 850±50 kg/m³.

10. The paper according to claim 1, wherein the paper is calendered.

11. The paper according to claim 1, wherein the paper has a smoothness of about 100±20 ml/min (Bentsen), in particular 100±15 ml/min or 100±10 ml/min (Bentsen), preferably about 95 to 85 ml/min (Bentsen).

12. The paper according to claim 1, wherein the Colour Image Quality and Black Text Quality as a function of Ink Absorption lies in the area between the two vertical lines corresponding to sample Ex. 1 and sample Ex. 3, respectively, in FIG. 1.

13. Method of producing a paper for high-speed inkjet printing, comprising
forming in a paper machine a cellulosic or lignocellulosic web, which contains fillers and an internal sizing agent,
characterized in that
applying on the surface of the paper web a cationic fixing agent in an amount which, together with the level of internal sizing agent, renders the paper properties of
a. black ink absorption which is 40%±10% of the absorption of coloured ink at 1.0. second and 70%±15% of the absorption of coloured ink at 2.0. seconds, and
b. maximum absorption determined by Emtec standard absorption analyses in the range of 0.3 to 0.5 seconds.

14. The method according to claim 13, wherein an internal sizing agent is mixed with cellulosic or lignocellulosic fibres for forming a furnish.

15. The method according to claim 14, wherein the internal sizing agent is an alkylketene dimer, derived from hydrocarbyl residues having from 8 to 30 carbon atoms, or an alkyl succhinic acid anhydride, wherein the alkyl residue comprises a linear or branched hydrocarbyl residue with 1 to 10 carbon atoms.

16. The method according to claim 15, wherein the concentration of alkyl succhinic acid anhydride used as an internal sizing agent is about 0.01 to 0.1%, preferably about 0.04-0.06%, in particular about 0.041 to 0.52% from the weight of the paper.

17. The method according to claim 13, comprising using a fixing agent selected from the group of aliphatic cationic polyamines and derivates thereof, polyethylene imine and derivatives thereof, polyamidoamines and derivatives thereof, polyamido amine epichlorohydrin resins, and polydiallyldimethyl ammonium chloride.

18. The method according to claim 17, wherein a cationic polyamine derivative is used as a fixing agent and it is applied in an amount of about 1.5 to 3 g/m², preferably about 1.75 to 2.25 g/m², in particular 1.80 to 2.20 g/m², for example about 2.00 g/m².

19. The method according to claim 17, wherein the cationic polyamine derivative is applied by size-press, film-press, spraying or by calendar.

20. The method according to claim 13, wherein the paper is calendered to a smoothness of about 100±20 ml/min by Bentsen, preferably about 100±15 ml/min (Bentsen), in particular about 95 to 85 ml/min (Bentsen).

21. (canceled)
